(19) United States
(12) Patent Application Publication
(10) Pub. No.: US 2002/0106157 A1
(43) Pub. Date: Aug. 8, 2002

(54) Method of making an optical waveguide fiber grating substrate and an optical device thereof

(76) Inventors: Chieh Hu, Taichung (TW); Shu-Mei Yang, Taichung Hsien (TW); Jyh-Chen Chen, Taoyuan Hsien (TW); Jui-Ping Weng, Miaoli Hsien (TW); Chen-Hung Huang, Taipei (TW)

Correspondence Address: BIRCH STEWART KOLASCH & BIRCH, PO BOX 747, FALLS CHURCH, VA, 22040-0747, US

(21) Appl. No.: 09/939,836

(22) Filed: Aug. 28, 2001

(30) Foreign Application Priority Data
Dec. 22, 2000 (TW) 89127690

(51) Int. Cl. G02B 6/34

(52) U.S. Cl. 385/37

(57) ABSTRACT

A method of making an optical waveguide fiber grating substrate comprising the steps of: providing a plurality of tungstenoxide particles and a plurality of zirconiumoxide particles; mixing and grinding the tungstenoxide particles and the zirconiumoxide particles; pressing the mixed and ground particles into a plane green body; and sintering the green body into a sintered body, the green body being loaded with a carrier plate and covered with a cover plate.

### BACKGROUND OF THE INVENTION

1. Field of the Invention

The present invention relates to a method of making an optical waveguide fiber grating substrate, and more particularly to a method of making an optical waveguide fiber grating substrate with a negative thermal coefficient of expansion.

2. Description of the Prior Art:

Dense Wavelength Division Multiplexing system (DWDM) used in optical fiber communication systems is gradually attached importance to. Conventional optical fiber gratings are relatively temperature sensitive. This sensitivity is generally undesirable but can be reduced or eliminated by attaching the grating to a support member having a negative coefficient of thermal expansion. Fleming et al. (U.S. Pat. No. 5,694,503) teach that the thermal expansion can be tailored by admixture of positive expansion coefficient material to the negative expansion coefficient material. Materials having a natural and inherent negative thermal coefficient of expansion and exhibiting isotropic negative thermal expansion, i.e., the materials contract equally (isotropically) in all directions during heating, the known ones such as ZrW₂O₈ and betaeucryptite glass-ceramic. The present invention focuses on ZrW₂O₈. The binary phase diagram of zirconium oxide with tungsten oxide is shown in FIG. 1. The equilibrium experiments indicates that ZrW₂O₈ can only be obtained as a single phase from ZrO₂ and WO₃ in the relative molar stoichiometry 2:1 through prolonged heating between 1105 and 1257° C.

Graham originally stated that the reaction of zirconium oxide with tungsten oxide to form zirconium tungstate was complete within about 15 minutes at 1200° C. The authors later recanted the success of the synthetic procedure, and stated that they were never able to prepare zirconium tungstate that was free of zirconium oxide and tungsten oxide. Graham et al.'s A New Ternary Oxide, ZrW₂O₈, J. Am. Ceram. Soc., Discussions and Notes, 42:570-571 (1959). This difficulty is apparently related to (1) the volatility of tungsten oxide at 1200° C., and (2) the reactivity, or lack thereof, of zirconium oxide under the synthetic conditions used by Graham. Chang also described a method for preparing zirconium and hafnium tungstate. Chang et al.'s Condensed Phase Relations in the Systems ZrO₂ —WO₂ —WO₃ and HfO₂ —WO₂ —WO₃, J. Am. Ceram. Soc., 50:211-215 (1967). Chang placed the respective reactants in sealed platinum tubes, primarily because of the volatility of WO₃ at elevated temperatures. Chang specifically states that “equilibrium experiments indicate that this compound zirconium tungstate! can only be obtained as a single phase from ZrO₂ and WO₃ in the proper stoichiometric ratio through prolonged heating, i.e., at least 24 hr. at 1200° C.” Chang et al., supra, at page 212. Martinek later refuted this statement. Martinek specifically stated that the “present work only confirmed the limited stability of ZrW₂O₈. The compound cannot be formed below 1105° C., and even at 1200° C. 48 hours were required to produce ZrW₂O₈ free of ZrO₂ and WO₃. “Martinek et al.'s Subsolidus Equilibria in the System ZrO₂ —WO₃ —P₂O₅, J. Am. Ceram. Soc., 53:159-161 (1970) . Sleight et al. (U.S. Pat. No. 5,514,360) teach that a tungstate compounds generally can be made by forming a solution, particularly an aqueous solution, comprising a W⁶⁺ compound and a second metal compound wherein the metal is selected from the group consisting of Zr⁴⁺, Hf⁴⁺ and combinations thereof. The solvent is removed from the solution by any known method to leave the solutes as a solid product. The solid product is then heated to a temperature of from about 1165° C. to about 1250° C. The heated product is then cooled to ambient temperature, generally relatively rapidly, to produce substantially single phase tungstate compounds. The object of the above method is used for producing pure ZrW₂O₈ but is unsuitable for producing high density ZrW₂O₈. Fleming et al. teach that ZrW₂O₈ particles are pressed and then heated to a temperature of about 1200° C., maintained for four hours and followed by rapid cooling to produce a ZrW₂O₈ substrate. The ZrW₂O₈ will decompose above 1050K during sintering. The ZrW₂O₈ particles will be reduced to tungstenoxide and zirconiumoxide at high temperature sintering and then react to ZrW₂O₈ again, during which the volatility of tungstenoxide occurs. In order to obtain the ZrW₂O₈ phase, the ZrW₂O₈ must be cooled rapidly to ambient temperature after sintering. Furthermore, the quenching process usually causes ultra high thermal stress and results in micro cracking of the quenching body.

### SUMMARY OF THE INVENTION

The object of the present invention is to solve the above-mentioned problems and to provide a method of making an optical waveguide fiber grating substrate and an optical device thereof. The method of the invention uses a carrier plate and a cover plate for a green body being sintered into a sintered body in order for the reduction of the volatility of the tungstenoxide and the uniform conduction of the heat during sintering. In addition, the method can help the sintered body evenly take off heat in a quench process, thus reduce microcrack occurrence. The method does not use ZrW₂O₈ powder to make ceramic, so the process is simplified, and avoids excessive sintering times, thus solving the complications experienced in the prior art. Thus the expense of the process can reduce and can make various thickness of the ceramic in need.

According to the present invention, a method of making an optical waveguide fiber grating substrate comprising the steps of: providing a plurality of tungstenoxide particles and a plurality of zirconiumoxide particles; mixing and grinding the tungstenoxide particles and the zirconiumoxide particles; pressing the mixed and ground particles into a plane green body; and sintering the green body into a sintered body, the green body being loaded with a carrier plate and covered with a cover plate.

According to the present invention, a method of making an optical device comprising the steps of: providing a ZrW2O8 substrate; forming a void in the substrate; positioning an optical waveguide fiber along the substrate; providing a heat adhesive or ultraviolet adhesive that flows into the void and affixes the optical waveguide fiber to the substrate proximate the void

### BRIEF DESCRIPION OF THE DRAWINGS

The present invention will be described in detail with reference to the illustrated embodiments and the accompany drawings.

FIG. 1 shows the binary phase diagram of zirconium oxide with tungsten oxide

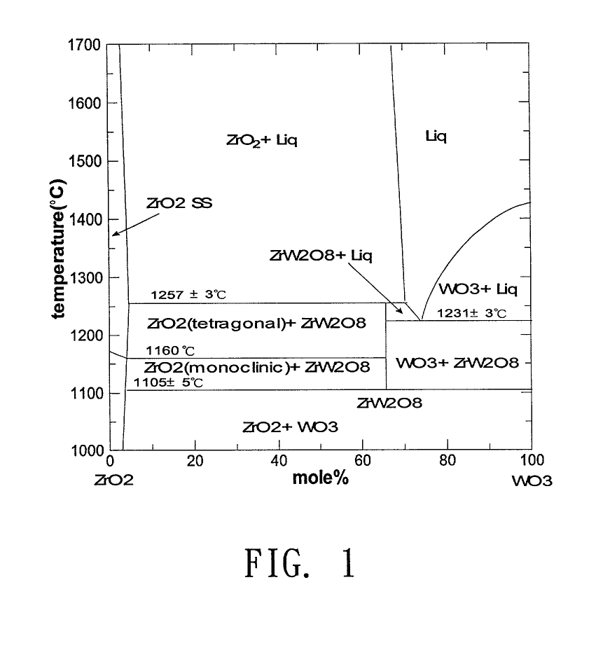

FIG. 2 is a perspective view illustrating the green body is loaded with the carrier plate and covered with the cover plate during sintering.

FIG. 3A shows the photograph of the sintered ZrW₂O₈ with a carrier plate and a cover plate.

FIG. 3B shows the photograph of the sintered ZrW₂O₈ without any cover.

FIG. 4 illustrates the thermal coefficients of expansion of various sintering duration.

FIG. 5 is a perspective view of a substrate of a device in which the present invention is embodied.

FIG. 6 is a perspective view of a device in which the present invention is embodied.

FIG. 7 is a perspective view of a device in which the present invention is embodied.

FIG. 8 is a perspective view of another substrate of a device in which the present invention is embodied.

FIG. 9 shows a diagram of wavelength versus temperature of the packaged fiber grating and an unpackaged fiber grating.

ATTACHMENT 1 shows the photograph of the sintered ZrW₂O₈ with a carrier plate and a cover plate during sintering of this invention.

ATTACHMENT 2 shows the photograph of the sintered ZrW₂O₈ without any cover during sintering.

ATTACHMENT 3 shows the results of numerical analysis for quenching the sintered ZrW₂O₈ with cover plates.

ATTACHMENT 4 shows the results of numerical analysis for quenching the sintered ZrW₂O₈ without any cover.

### DETAILED DESCRIPTION OF THE INVENTION

Method of making an optical waveguide fiber grating substrate and an optical device thereof according to the present invention will now be described.

A plurality of tungstenoxide particles and a plurality of zirconiumoxide particles are first provided. The tungstenoxide particles and the zirconiumoxide particles are mixed preferably with a relative molar stoichiometry within a range between 1.5:1 and 3:1, more preferably 2:1.

The tungstenoxide particles and the zirconiumoxide particles are then mixed and grinded, such as performed with ball milling. Next, the mixed and ground particles are pressed into a plane green body.

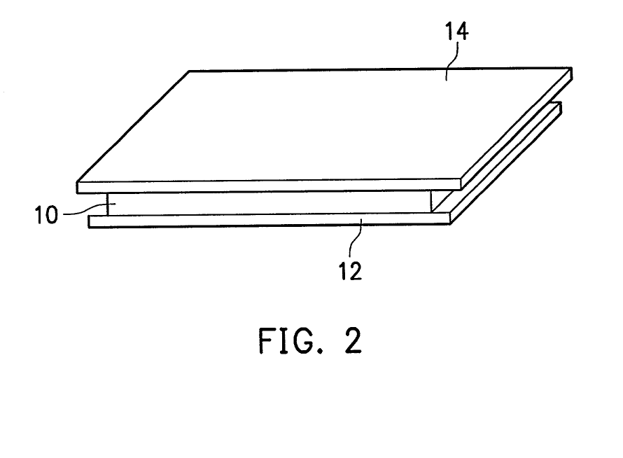

Then, the green body is sintered into a sintered body and the green body is loaded with a carrier plate and covered with a cover plate in order for the reduction of the volatility of the tungstenoxide during sintering. FIG. 2 illustrates the green body 10 is loaded with the carrier plate 12 and covered with the cover plate 14 during sintering. A material of the carrier plate and the cover plate can be platinum, metal, or ceramic. Temperatures of sintering the green body are preferably between 1150 and 1250° C., more preferably between 1180 and 1200° C. A period of sintering the green body is preferably between four and twelve hours, more preferably between seven and nine hours.

Finally, the sintered body is rapid cooled to ambient temperature resulting in completing an optical waveguide fiber grating ZrW₂O₈ substrate.

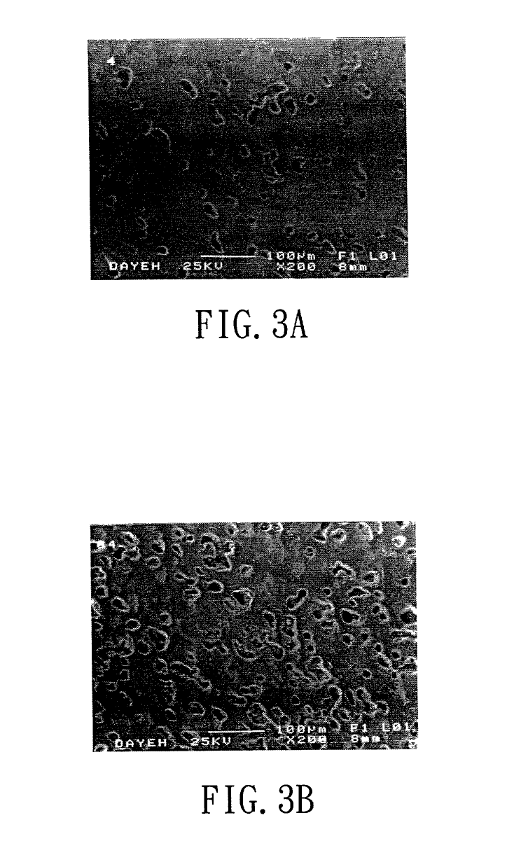

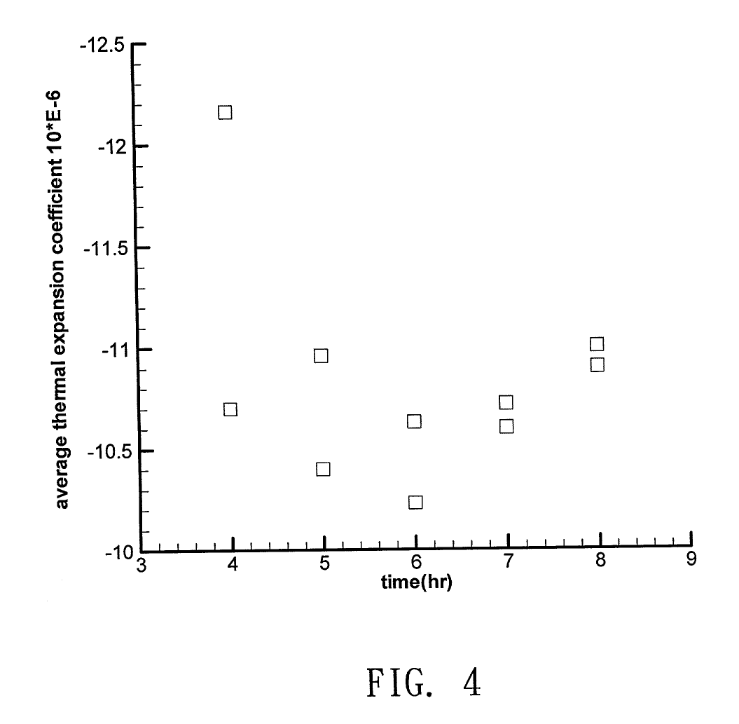

ATTACHMENT 1 shows the photograph of the sintered ZrW₂O₈ with a carrier plate and a cover plate during sintering of this invention. As can be seen, the upper and down faces of this sintered ZrW₂O₈ are even green color and the periphery without covering during sintering is ivory color. The portions or ivory color result from volatilizing of tungstenoxide synthesizing in high temperature, and these portions cannot be applied for their loose structure and porosity. ATTACHMENT 2 shows the photograph of the sintered ZrW₂O₈ without any cover during sintering. As can be seen, the whole upper face of this sintered ZrW₂O₈ is ivory color, so the available area of this sintered ZrW₂O₈ is small. Another evidence can also be seen from the photographs of scanning electron microscope (SEM). FIG. 3A shows the photograph of the sintered ZrW₂O₈ with a carrier plate and a cover plate, as can be seen, whose pores are much less than the sintered ZrW₂O₈ without any cover during sintering (its SEM photograph is shown in FIG. 3B). The thermal coefficients of expansion of the sintered ZrW₂O₈ during sintering appear a negative characteristic from 30 to 300° C., and the thermal coefficient of expansion achieves −11.13×10⁻⁶K⁻¹ better than that of the sintered ZrW₂O₈ without cover −10.12×10⁻⁶K⁻¹. The quench process of the sintered ZrW₂O₈ is then simulated with numerical analysis to verify having cover plates whether can benefit in heat removing evenly. It is assumed that the quench process is natural convection, and takes the sintered ZrW₂O₈ after quenching 420 second for analyzing. ATTACHMENT 3 shows the results of numerical analysis for quenching the sintered ZrW₂O₈ with cover plates. As can be seen, the whole temperature distribution is uniform, and its temperature gradient is less than that of the sintered ZrW₂O₈ without cover (shown in ATTACHMENT 4), thus the sintered ZrW₂O₈ with cover plates can decrease its internal stress. Therefore, the sintered ZrW₂O₈ having cover plates during sintering benefit in making ZrW₂O₈.

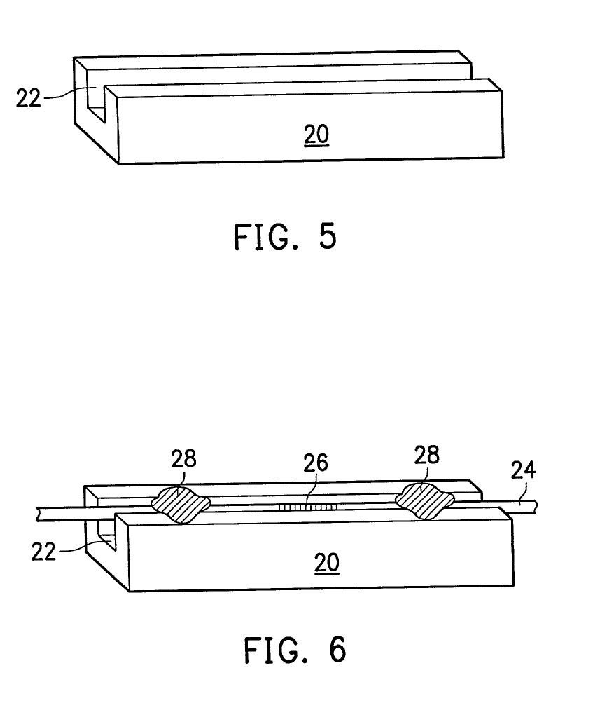

Using a carrier plate and a cover plate for green body during sintering can make the sintered ZrW₂O₈ with stable thermal coefficients of expansion. FIG. 4 illustrates the thermal coefficients of expansion of various sintering duration for making the ZrW₂O₈. As can be seen, the fluctuating range of thermal coefficients of expansion for sintering 4 hours is large; however, the fluctuating range as the duration getting long is getting small. The thermal coefficients of expansion converge to a certain value for the duration being 8 hours. Therefore, it can be concluded that sintering a green body with a cover platinum plate must prolong at least 8 hours to obtain the sintered ZrW₂O₈ with stable thermal coefficients of expansion.

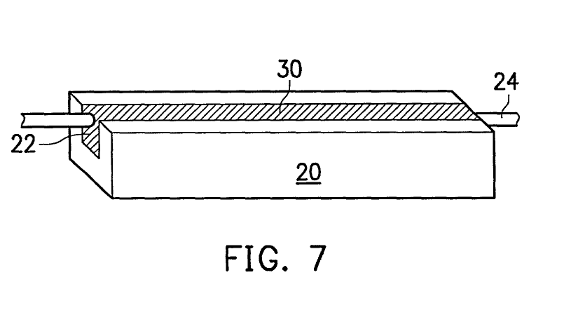

An optical waveguide fiber can be located along the sintered ZrW₂O₈ substrate to complete an optical device. An exemplary embodiment of the inventive optical device is shown in FIG. 5. The sintered ZrW₂O₈ substrate is first machined to form an optical waveguide fiber grating substrate 20 with a proper size. The substrate 20 is then machined to form a void 22 in the substrate 20. The step of forming a void 22 may include the step of drilling holes into substrate 20.

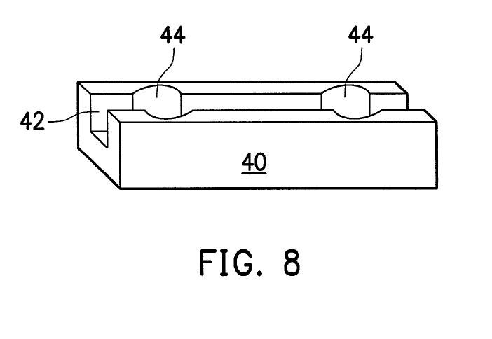

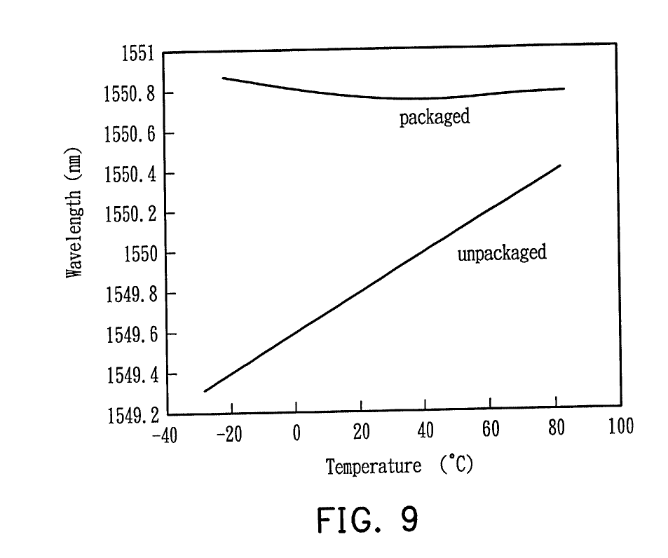

Refereeing to FIG. 6, an optical waveguide fiber 24 is positioned along the substrate 20. The optical waveguide fiber 24 contains an exposed grating 26 in the central position. Finally, optical waveguide fiber 24 is affixed to substrate 20 preferably using a heat adhesive or ultraviolet adhesive that flows into the void 22 and affixes the optical waveguide fiber 24 to the substrate proximate the void 22. FIG. 7 shows the void 22 is full filled with a heat adhesive or ultraviolet adhesive.

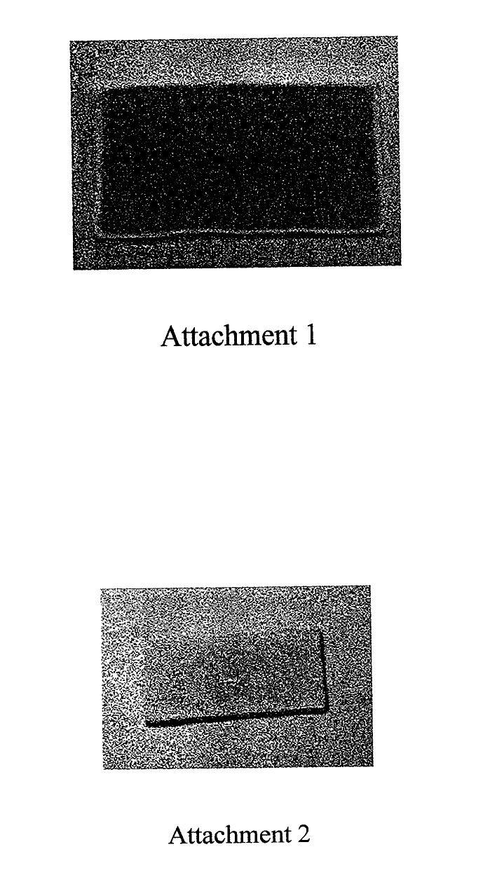

Another exemplary embodiment of the inventive optical device is shown in FIG. 8. The sintered ZrW₂O₈ substrate is first machined to form an optical waveguide fiber grating substrate 40 with a proper size. The substrate 40 is then machined to form a void 42 and two holes 44 in the substrate 40. The two additional holes 44 locate on the adhesive position to improve the reliability.

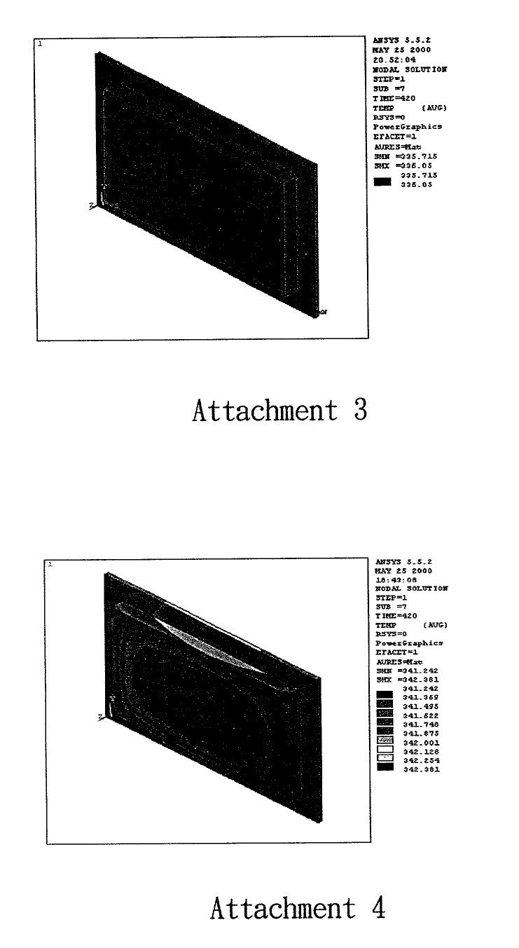

FIG. 9 shows a diagram of wavelength versus temperature of the packaged grating and an unpackaged grating. The overall temperature dependence of the unpackaged grating is found to be 0.012 nm/° C., and that of the packaged grating is 0.001 nm/° C. The improvement of sensitivity for temperature is significant and evident.

While the invention has been described with reference to various illustrative embodiments, the description is not intended to be construed in a limiting sense. Various modifications of the illustrative embodiments, as well as other embodiments of the invention, will be apparent to those persons skilled in the art upon reference to this description. It is therefore contemplated that the appended claims will cover any such modifications or embodiments as may fall within the scope of the invention defined by the following claims and their equivalents.

What is claimed is:

1. A method of making an optical waveguide fiber grating substrate comprising the steps of:
providing a plurality of tungstenoxide particles and a plurality of zirconiumoxide particles;
mixing and grinding said tungstenoxide particles and said zirconiumoxide particles;
pressing said mixed and ground particles into a plane green body; and
sintering said green body into a sintered body, said green body being loaded with a carrier plate and covered with a cover plate.

2. The method as recited in claim 1, wherein said tungstenoxide particles and said zirconiumoxide particles are mixed with a relative molar stoichiometry within a range between 1.5:1 and 3:1.

3. The method as recited in claim 1, wherein said tungstenoxide particles and said zirconiumoxide particles are mixed with a relative molar stoichiometry 2:1.

4. The method as recited in claim 1, wherein mixing and grinding said tungstenoxide particles is performed by ball milling.

5. The method as recited in claim 1, wherein a material of said carrier plate and said cover plate is selected from the group consisting of platinum, metal, and ceramic.

6. The method as recited in claim 1, wherein duration of sintering said green body is between four and twelve hours.

7. The method as recited in claim 1, wherein duration of sintering said green body is between seven and nine hours.

8. The method as recited in claim 1, wherein temperatures of sintering said green body are between 1150 and 1250° C.

9. The method as recited in claim 1, wherein temperatures of sintering said green body are between 1180 and 1200° C.

10. The method as recited in claim 1, further comprises rapid cooling said sintered body to ambient temperature.

11. The method as recited in claim 1, further comprises machining said sintered body to form a void in said optical waveguide fiber grating substrate.

12. A method of making an optical device comprising the steps of:
providing a ZrW₂O₈ substrate;
forming a void and two holes in said substrate;
positioning an optical waveguide fiber along said substrate;
providing a heat adhesive or ultraviolet adhesive that flows into said void and said two holes and affixes said optical waveguide fiber to said substrate proximate said void; and
a method of making said ZrW₂O₈ substrate comprising the steps of:
providing a plurality of tungstenoxide particles and a plurality of zirconiumoxide particles;
mixing and grinding said tungstenoxide particles and said zirconiumoxide particles;
pressing said mixed and ground particles into a plane green body; and
sintering said green body into a sintered body, said green body being loaded with a carrier plate and covered with a cover plate.

13. The method as recited in claim 12, wherein said tungstenoxide particles and said zirconiumoxide particles are mixed with a relative molar stoichiometry within a range between 1.5:1 and 3:1.

14. The method as recited in claim 12, wherein said tungstenoxide particles and said zirconiumoxide particles are mixed with a relative molar stoichiometry 2:1.

15. The method as recited in claim 12, wherein mixing and grinding said tungstenoxide particles is performed by ball milling.

16. The method as recited in claim 12, wherein a material of said carrier plate and said cover plate is selected from the group consisting of platinum, metal, and ceramic.

17. The method as recited in claim 12, wherein duration of sintering said green body is between seven and nine hours.

18. The method as recited in claim 1, wherein temperatures of sintering said green body are between 1180 and 1200° C.

19. The method as recited in claim 1, further comprises rapid cooling said sintered body to ambient temperature.
